(19) United States
(12) Patent Application Publication
(10) Pub. No.: US 2003/0032434 A1
(43) Pub. Date: Feb. 13, 2003

(54) Systems and methods to facilitate compliance with location dependent requirements

(76) Inventors: Barry E. Willner, Briarcliff Manor, NY (US); John J. Shedletsky, Brewster, NY (US); Edith H. Stern, Yorktown Heights, NY (US); Philip Shi-lung Yu, Chappaqua, NY (US); David P. Greene, Ossining, NY (US)

Correspondence Address: BUCKLEY, MASCHOFF, TALWALKAR, & ALLISON, 5 ELM STREET, NEW CANAAN, CT, 06840, US

(21) Appl. No.: 09/923,492

(22) Filed: Aug. 7, 2001

(51) Int. Cl. H04Q 7/20

(52) U.S. Cl. 455/456; 455/459

(57) ABSTRACT

Systems and methods are provided to facilitate compliance with location dependent requirements, such as laws and regulations that vary from jurisdiction to jurisdiction. According to one embodiment, location information associated with a user is determined. Requirement information is then determined based on the location information. The user's compliance with the requirement information is then facilitated, such as by displaying an appropriate indication to the user.

### FIELD

The present invention relates to compliance with location dependent requirements, such as laws and regulations that vary from jurisdiction to jurisdiction.

### BACKGROUND

A person often needs to comply with requirements that apply based on his or her current location. That is, laws or regulations can vary from country to country, from state to state, or even from town to town. For example, some jurisdictions let a driver make right turn after stopping at a red light. Other jurisdictions do not. Similarly, some jurisdictions let a driver use a wireless telephone while driving. Other jurisdictions do not—or at least require that a wireless telephone be used in “hands-free” fashion. As still another example, the purchase of an item may be subject to restrictions that depend on the location of the purchase (e.g., restrictions associated with a customer's age, a time of day, or a day of week).

To comply with these types of requirements, a person must be aware of the requirements. For example, a person may need to know that the speed limit in a particular town is 35 miles per hour. It is not realistic, however, to expect that a person can know every requirement that may be applicable (e.g., especially if the person travels through a number of different jurisdictions). Moreover, the person might not even know his or her current location. For example, a winding road may pass back and forth between two jurisdictions (with each jurisdiction having a different set of requirements). These problems obviously make it difficult for people to comply with location dependent requirements.

Similarly, governmental or other authorities want to ensure that people are aware of applicable requirements. That is, the purpose of a requirement is to encourage (or discourage) a particular type of action—but can only have that effect if people are aware of the requirement. Moreover, in some cases a penalty is not applied to a person who violates a requirement unless he or she was notified about the requirement. For example, a state may not want (or be allowed) to penalize a driver who does not wear a seat belt unless he or she knew that the state required drivers to wear seat belts.

To address these problems, some jurisdictions place signs on the roads that lead into the jurisdiction. For example, a town may post speed limit signs at its boarders. However, such an undertaking is expensive, and it may not be practical to place a sign on every road (e.g., signs are typically only placed on major roads). As a result, many people will not be aware of the requirement. Another disadvantage with this approach is that all of the signs need to be replaced if the requirement is changed.

It may be impractical to notify a person about every requirement he or she needs to know—particularly if there are a large number of requirements or if the requirements are complex. For example, the types of items that may be transported over a bridge or through a tunnel are often restricted (e.g., certain chemicals or explosives may be prohibited). In this case, a truck driver is expected to ensure that his or her truck is not carrying a restricted items. This task can be difficult (e.g., when the list of restricted items is exhaustive) and may lead to errors. To simplify the task, “categories” of items may be restricted, such as U.S. Department of Transportation Hazardous Materials (HAZMAT) categories. Even so, mistakes can be made and the authority must notify a large number of truck drivers about any change to the categories.

### SUMMARY

To alleviate problems inherent in the prior art, the present invention introduces systems and methods to facilitate compliance with location dependent requirements.

According to one embodiment, location information associated with a user is determined. Requirement information is then determined based on the location information, and the user's compliance with the requirement information is facilitated.

According to another embodiment, current location information is received from a remote mobile user device via a communication network. A current legal requirement is then determined based on the location information. If the current legal requirement differs from a prior legal requirement, an indication of the current legal requirement is transmitted to the user device.

According to still another embodiment, requirement information is determined along with a current location associated with a user. Location information is then determined based on the requirement information and the current location, and the user's compliance with the requirement information is facilitated.

One embodiment of the present invention comprises: means for determining location information associated with a user; means for determining requirement information based on the location information; and means for facilitating the user's compliance with the requirement information.

Another embodiment of the present invention comprises: means for receiving current location information from a remote mobile user device via a communication network; means for determining a current legal requirement based on the location information; and means for transmitting an indication of the current legal requirement to the user device if the current legal requirement differs from a prior legal requirement.

Still another embodiment of the present invention comprises: means for determining requirement information; means for determining a current location associated with a user; means for determining location information based on the requirement information and the current location; and means for facilitating the user's compliance with the requirement information.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a compliance system according to an embodiment of the present invention.

FIG. 2 is a flow chart of a method according to some embodiments of the present invention.

FIG. 3 illustrates a wireless telephone displaying compliance information according to one embodiment of the present invention.

FIG. 4 is a block diagram of a requirement controller according to an embodiment of the present invention.

FIG. 5 is a tabular representation of a portion of a location dependent requirement database according to an embodiment of the present invention.

FIG. 6 is a tabular representation of a record in a requirement request database according to an embodiment of the present invention.

FIG. 7 is a flow chart of a method according to another embodiment of the present invention.

FIG. 8 is a block diagram overview of a user system according to another embodiment of the present invention.

### DETAILED DESCRIPTION

Embodiments of the present invention are directed to systems and methods for facilitating compliance with “location dependent requirements.” As used herein, the phrase “location dependent requirement” may refer to any law, regulation, or rule that is applicable based on the location of a person (or a device). The requirement may be, for example, associated with a country, a state, a county, a town, or an employer (e.g., FEDERAL EXPRESS® may have a requirement that only applies to an employee when he or she is driving in New York city).

Compliance System Overview

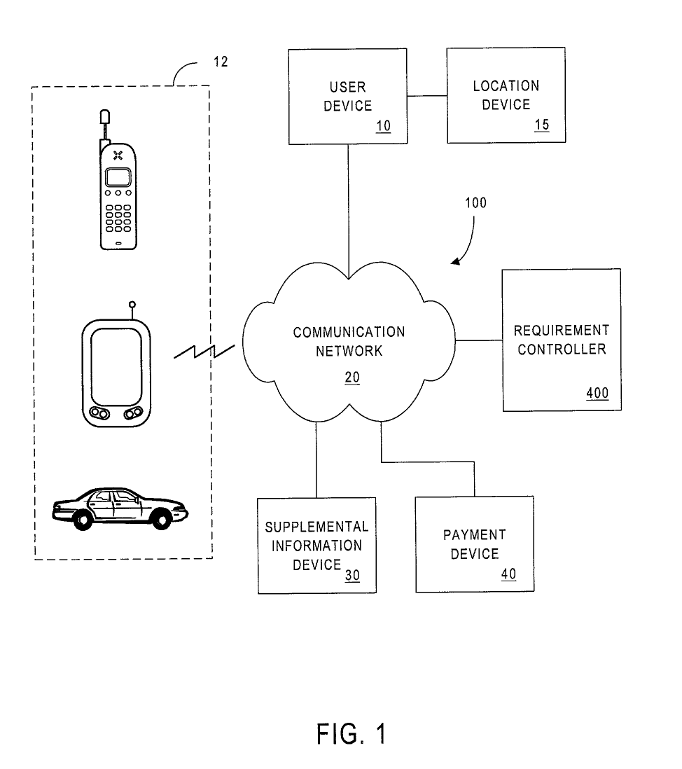

Turning now in detail to the drawings, FIG. 1 is a block diagram of a compliance system 100 according to one embodiment of the present invention. The compliance system 100 includes a requirement controller 400 in communication with a user device 10. As used herein, devices (such as the requirement controller 400 and the user device 10) may communicate via a communication network 20, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11 standard), an Infrared Radiation (IR) network, or an Internet Protocol (IP) network such as the Internet, an intranet or an extranet.

For example, the requirement controller 400 may communicate with a mobile user device 10 using Bluetooth technology. Bluetooth technology allows a wide range of computing and telecommunication devices to be interconnected via wireless connections. Specifications and other information regarding Bluetooth technology are available at the Bluetooth Web site www.bluetooth.com. In embodiments utilizing Bluetooth technology, communicating devices may be equipped with a microchip transceiver that transmits and receives information in a frequency band of 2.45 GHz (with some variation of bandwidth in different countries). Connections may be point-to-point or multipoint over a maximum range, such as ten meters. Embodiments using Bluetooth technology may require the additional use of one or more communication stations (e.g., a number of communication stations may be positioned throughout a location, and a communication station may relay information between the requirement controller 400 and one or more mobile user devices 10).

Although a single requirement controller 400 is shown in FIG. 1, any number of requirement controllers 400 may be included in the compliance system 100. Similarly, any number of user devices 10, or any of the other devices described herein, may be included in the compliance system 100 according to embodiments of the present invention.

The requirement controller 400 and the mobile user devices 400 may be any devices capable of performing the various functions described herein. Some specific examples of user devices 12 are illustrated in FIG. 1. A user device 10 may be, for example: a wireless telephone, a portable computing device such as a laptop computer or Personal Digital Assistant (PDA), a vehicle (e.g., an automobile), a one-way or two-way pager, or any other appropriate communication device. According to one embodiment, the user device 10 provides to the user an indication associated with a requirement (e.g., by displaying the requirement to the user). According to some embodiments, the requirement is associated with the use or operation of the user device 10. For example, the user device 10 may be a container (e.g., a truck transportation container or a suitcase that might contain restricted items) or a weapon.

According to one embodiment, the user device 10 receives current location information from a location device 15. The location device 15 may be, for example, a Global Positioning Satellite (GPS) device that transmits latitude and longitude information to the user device 10. The location device 15 may also be, for example, a wireless communication network device (e.g., a wireless telephone or a Bluetooth device).

The requirement controller 400 and/or the user device 10 may also communicate with a supplemental information device 30. For example, the supplemental information device 30 may provide weather information. The requirement controller 400 and/or the user device 10 may also communicate with a payment device 40. For example, the payment device 40 may arrange for a user to provide payment of a subscription amount in exchange for access to the compliance system.

Note that the devices shown in FIG. 1 need not be in constant communication. For example, the requirement controller 400 may communicate with a user device 10 on an as-needed or periodic basis. Similarly, the requirement controller 400 might communicate with a mobile user device 10 only when the mobile user device 10 is located near the requirement controller 400.

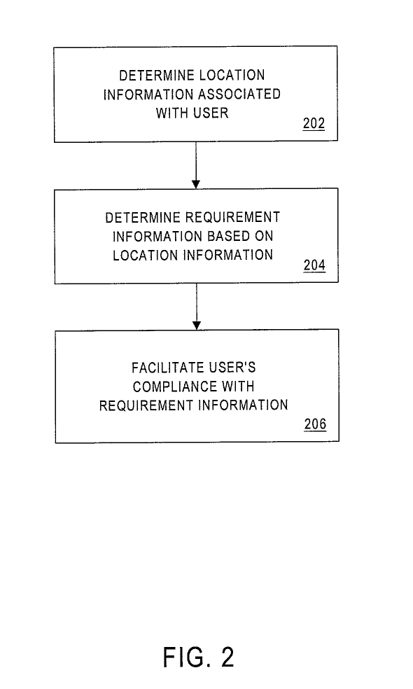

FIG. 2 is a flow chart of a method according to an embodiment of the present invention. The flow charts in FIG. 2 and the other figures described herein do not imply a fixed order to the steps, and embodiments of the present invention can be practiced in any order that is practicable. The method shown in FIG. 2 may be performed, for example, by the requirement controller 400 and/or the user device 10.

At 202, location information associated with a user is determined. The location information may comprise, for example, latitude and longitude information, map coordinate information (e.g., “C3”), a location type (e.g., indicating that the user is currently on an interstate highway), and/or an indication of a geographic region (e.g., indicating that the user is currently in New York state). According to one embodiment, the user device 10 determines the location information based on information received from the location device 15.

According to another embodiment, the requirement controller 400 determines the location information based on information received from a remote user device 10 (e.g., after being generated by the location device 15). For example, the user device 10 may periodically transmit a current location to the requirement controller 400.

According to another embodiment, the user device 10 instead transmits location information to the requirement controller 400 upon a change in a location type (e.g., when the user enters a new jurisdiction). According to still another embodiment, the user device 10 transmits the location information to the requirement controller 400 in association with a requirement request (e.g., the user may ask the location controller 400 to determine if a particular action is permitted in a particular location).

Note that the determination of location information may be a multi-step process. For example, the location device 15 may transmit latitude and longitude information to the user device 10. The user device 10 may then translate the latitude and longitude into an indication associated with a jurisdiction (e.g., indicating a particular state, a town, or highway). According to another embodiment, the requirement controller 400 performs such a translation instead.

At 204, requirement information is determined based on the location information. According to one embodiment, the user device 10 determines requirement information by receiving information from the requirement controller 400.

According to another embodiment, the requirement controller 400 determines the requirement information by retrieving pre-stored information from a database based on the location information. According to other embodiments, a rules-based system, a statistical analysis, human judgment (e.g., a decision by a lawyer or a paralegal), and/or a third-party service are used to determine the requirement information.

At 206, the user's compliance with the requirement information is facilitated. For example, the requirement controller 400 may transmit requirement information to the user device 10 facilitate the user's compliance.

According to one embodiment, the user's compliance is facilitated by arranging for an indication to be provided to the user in accordance with the requirement information. For example, the user device 10 may provide text information, audio information, and/or graphical information to help the user comply with a location dependent requirement. The indication may include a description of a requirement (e.g., describing an action that the user can or cannot perform) and/or a penalty associated with the requirement.

According to some embodiments, the user's compliance is further facilitated based on supplemental information, such as information associated with the operation of the user device 10. Consider, for example, a driver of an automobile who is currently located in a town that does not let a driver make a right turn when a light is red. In this case, a message may be displayed on the driver's windshield (e.g., “no right on red”) only if: (i) he or she is currently stopped at a red light and (ii) he or she is currently signaling that a right turn will be made. Other types of supplemental information include weather information (e.g., in association with a requirement that headlights be turned on when it is raining), a current time and date (e.g., when a particular item may not purchased after midnight or on a Sunday) and/or user information (e.g., his or her age or driver's license class).

According to one embodiment, the user's compliance with a requirement is facilitated by automatically arranging for the user device 10 to operate in accordance with the requirement information. For example, the volume of an automobile stereo may automatically be lowered when the automobile is near a hospital.

Note that the requirement controller 400 may facilitate compliance with respect to a number of different location dependent requirement types (e.g., driving requirements and shopping requirements).

In addition to location information, the requirement controller 400 may facilitate compliance based on a user identifier, a user device identifier, and/or user preference information (e.g., a user may indicate that he or she always wants to know driving requirements but not shopping requirements).

### EXAMPLES

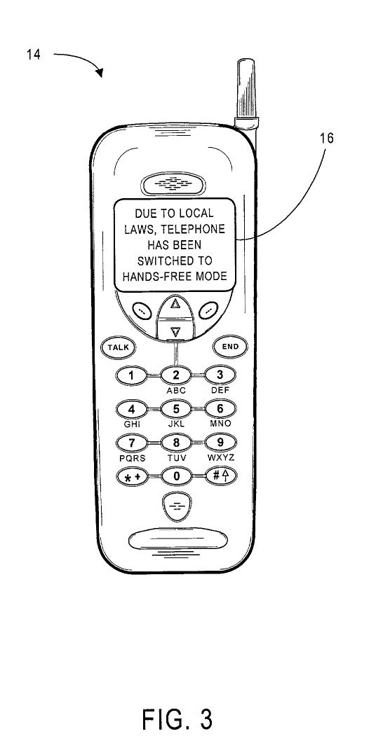

Consider Alice, who is driving while using a wireless telephones in state where this action is permitted. Without realizing it, Alice travels into a neighboring state where it is not permitted unless a “hands-free” wireless telephone mode is used. Based on an information received from a remote requirement controller 400, Alice's wireless telephone automatically switches to such a “hands-free” mode. FIG. 3 illustrates a wireless telephone 14 displaying compliance information 16 in accordance with such an example.

Bob is driving in a city that does not let a driver make a right turn after stopping at a red light. Bob stops at a red light and activates his right turn signal. A device in Bob's automobile detects that Bob is stopped at a red light (e.g., based on Bluetooth information received from the traffic light) and that the right turn signal is activated. The device transmits a requirement request to a remote requirement controller 400 including (i) the automobile's current latitude and longitude as determined by a GPS device, and (ii) a query asking if a right turn is permitted at this location. Based on a response received from the requirement controller 400, the right turn signal on the automobile's dashboard is changed from a green arrow to a red arrow (i.e., indicating to Bob that he cannot make a right turn at this time).

Carol is driving a truck carrying a Bluetooth-enabled transportation container. A device in her truck communicates with the container and stores a list of items in the container. As Carol's truck approaches a tunnel, the device receives a list of items that cannot be transported through the tunnel (e.g., by receiving the list from a requirement controller 400 associated with a tunnel authority). The device compares the two lists, alerts Carol (as well as the tunnel authority device), and suggests an alternate route that she would be allowed to take.

David uses his PDA to search for a list of local wine stores on a Sunday. The PDA displays a list of four local wine stores along with a message stating that wine cannot be purchased at three of those stores on that day (e.g., because it is a Sunday and those three stores are located in state that prohibits the sale of alcohol on Sundays).

Emily is carrying a handgun. Based on information received from a remote requirement controller 400, the handgun emits an audible alarm to let her know that she is entering an area where she is not authorized to carry the handgun (e.g., an airport terminal or a school zone).

Requirement Controller

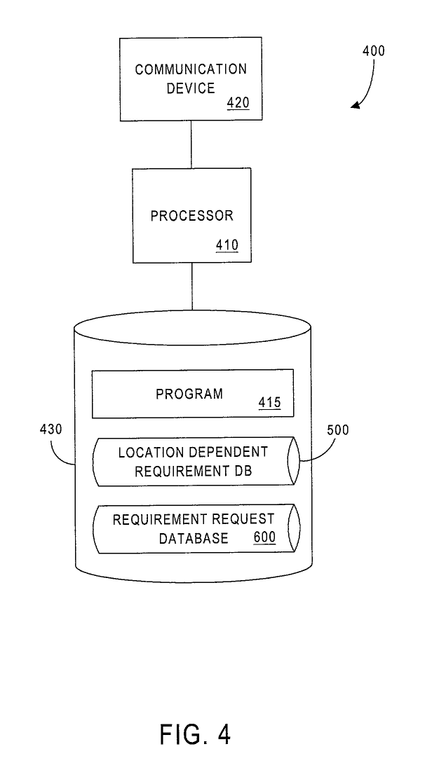

FIG. 4 illustrates an requirement controller 400 that is descriptive of the device shown, for example, in FIG. 1 according to some embodiments of the present invention. The requirement controller 400 comprises a processor 410, such as one or more INTEL® Pentium® processors, coupled to a communication device 420 configured to communicate via a communication network (not shown in FIG. 4). The communication device 420 may be used to communicate, for example, with one or more user devices 10, supplemental information devices 30, and/or payment devices 40.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 430 stores a program 415 for controlling the processor 410. The processor 410 performs instructions of the program 415, and thereby operates in accordance with the present invention. For example, the processor 410 may determine location information associated with a user. The processor 410 may also determine requirement information based on the location information and facilitate the user's compliance with the requirement information.

According to another embodiment, the processor 410 receives current location information from a remote mobile user device 10 via a communication network 20. The processor 410 then determines a current legal requirement based on the location information. If the current legal requirement differs from a prior legal requirement (i.e., the legal requirement has changed), the processor 410 transmits an indication of the current legal requirement to the user device 10.

As used herein, information may be “received” by or “transmitted” to, for example: (i) the requirement controller 400 from the user device 10; or (ii) a software application or module within the requirement controller 400 from another software application, module, or any other source.

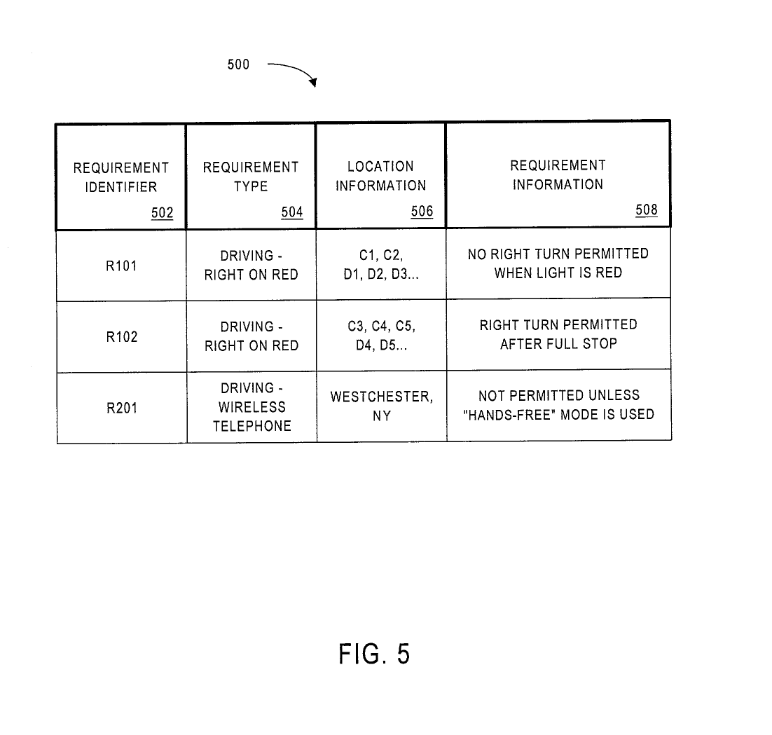

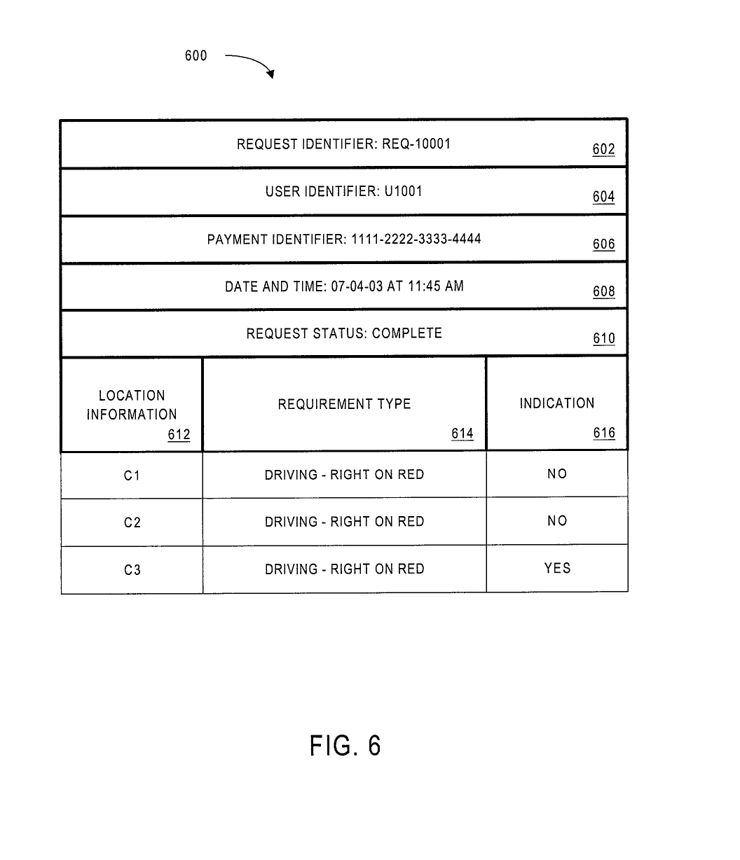

As shown in FIG. 4, the storage device 430 also stores a location dependent requirement database 500 (described with respect to FIG. 5) and a requirement request database 600 (described with respect to FIG. 6). According to some embodiments, these databases are stored at the requirement controller 400. According to other embodiments, these databases are remotely located and/or distributed. For example, a third-party service may maintain the location dependent requirement database 500. Examples of databases that may be used in connection with the compliance system 100 will now be described in detail. The illustrations and accompanying descriptions of the databases presented herein are exemplary, and any number of other database arrangements could be employed besides those suggested by the figures.

Location Dependent Requirement Database

Referring to FIG. 5, a table represents the location dependent requirement database 500 that may be stored at the requirement controller 400 according to an embodiment of the present invention. The table includes entries identifying requirements that are monitored by the compliance system 100. The table also defines fields 502, 504, 506, 508 for each of the entries. The fields specify: a requirement identifier 502, a requirement type 504, location information 506, and requirement information 508. The information in the location dependent requirement database 500 may be created and updated, for example, based on information received from one or more governmental authorities. According to one embodiment, a third party service creates and/or updates the information in the location dependent requirement database 500 (e.g., based on information gathered and from a number of different jurisdictions).

The requirement identifier 502 may be, for example, an alphanumeric code associated with a requirement that is monitored by the compliance system 100. The requirement type 504 indicates a type of requirement (e.g., a “driving” requirement in general or, more specifically, a “driving—wireless telephone” requirement). The location information 506 indicates the geographic area or areas in which the requirement is applicable (e.g., via map coordinates, latitude and longitude information, geographic or political areas, ZIP codes, or street address information). The requirement information 508 describes in the requirement (e.g., what actions are, or are not, permitted). According to one embodiment, the location dependent requirement database 500 also stores information about a penalty that may be applied if a user does not comply with a requirement (e.g., an amount of a fine).

For example, as illustrated by the first and second entries, a right turn is not permitted at a red light in “C1” or “C2” (i.e., as indicated by the first entry's location information 506 and requirement information 508) but is permitted (after a full stop) in “C3” (i.e., as indicated by the second entry's location information 506 and requirement information 508).

Requirement Request Database

Referring to FIG. 6, a table represents a record in the requirement request database 600 that may be stored at the requirement controller 400 according to an embodiment of the present invention. The database includes records associated with requirement requests that have been received from a user (or a user device 10) via the compliance system 100.

As shown in FIG. 6, each record includes a request identifier 602 and a user identifier 604 associated with a request and a user who made the request, respectively. Each record may also includes a payment identifier 606 associated with the request. The payment identifier 606 may comprise, for example, a credit card, debit card or bank account number (e.g., a checking account number) or digital payment protocol information. The payment identifier 606 may be used, for example, by the requirement controller 400 to arrange for the user to provide a payment (e.g., on a subscription or request-by-request basis). A date and time 608 indicate when the request was received, and a request status 610 indicates whether the request is “in process” or “complete.”

The table also defines fields 612, 614, 616 for each record. The fields specify: location information 612, a requirement type 614, and an indication 616.

The location information 612 indicates where the user (or user device) was when the request was made. The location information 612 may be based on, or associated with, the location information 506 stored in the location dependent requirement database 500.

The requirement type 614 may indicate a type of action associated with the request. The requirement type 614 may be based on, or associated with, the requirement type 504 stored in the location dependent requirement database 500.

The indication 616 is associated with the information that was provided to the user (or the user device 10) in response to the request. For example, an indication 616 of “no” was provided when the user was in “C1” and “C2” (i.e., he or she was not allowed to make a right turn at a red light) and an indication of “yes” was provided when the user was in “C3” (i.e., he or she was allowed to make a right turn at a red light).

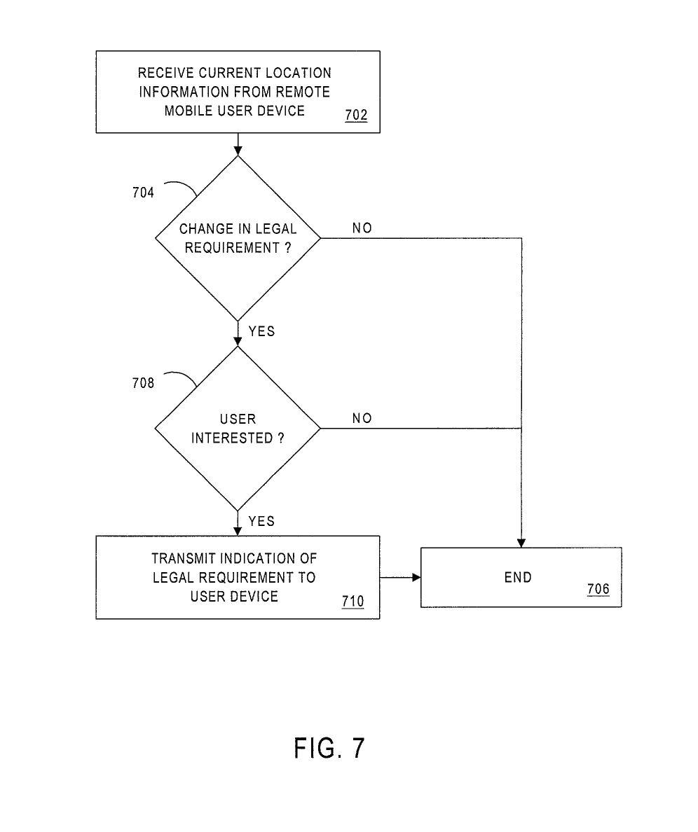

A method that may be used in connection with the compliance system 100 according to an embodiment of the present invention will now be described in detail with respect to FIG. 7.

Compliance System Method

FIG. 7 is a flow chart of a computer-implemented method to facilitate compliance with location dependent legal requirements according to some embodiments of the present invention. The method may be performed, for example, by the requirement controller 400.

At 702, current location information is received from a remote mobile user device 10 via a communication network 20. At 704, it is determined if a current legal requirement (based on the location information) differs from a prior legal requirement that was indicated to the user. For example, the current location information and the location dependent requirement database 500 may be accessed to determine if the legal requirement has changed (e.g., because the user has entered a new town). If the requirement has not changed, the process ends at 706 (e.g., the user is not told that the “speed limit is still thirty five miles per hour”).

At 708, it is determined if the user is interested in the new legal requirement. For example, a user may select which requirements he or she wants to know when registering with a compliance service (e.g., a typical user may have no interest in hazardous materials transportation regulations). If the user is not interested in the new legal requirement, the process ends at 706.

If the user is interested in the new legal requirement, an indication of the legal requirement is transmitted to the user device 10. The user device 10 may then display the legal requirement to the user and/or automatically operate in compliance with the legal requirement.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated with a user device 10 transmitting location information to a requirement controller 400, a user may not want his or her location to be reported and/or recorded (e.g., for privacy reasons). In this case, an anonymous user identifier and/or encryption techniques may be used. In another embodiment, user devices 10 communicate with each other to facilitate compliance (e.g., via a peer-to-peer architecture).

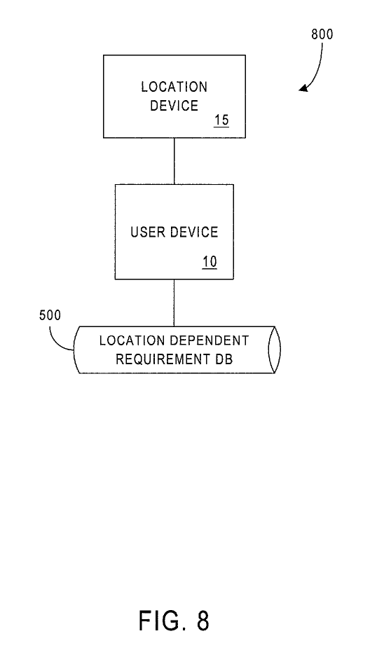

As another approach, consider the compliance system shown in FIG. 8. In this case, the location dependent requirement database 500 is stored locally at the user device 10. In this way, the user device 10 may determine location information (e.g., based on information received from the location device 15) and requirement information without sending any information to the requirement controller 400. Note that the location dependent requirement database 500 can still be based on information received from a requirement controller 400 (e.g., the requirement controller 400 may download requirement information to the user device 10 on a weekly basis).

In addition, in many embodiments described herein a requirement is displayed to a user based on his or her location. According to another embodiment, however, a location is displayed to the user instead. For example, the compliance system 100 may determine the nearest town in which a user can purchase a particular product, and direct the user to that town.

Moreover, although many embodiments have been described with respect to automobiles, the present invention is applicable to many types of vehicles, including trains, boats, and airplanes. In the case of an airplane, the location information may be three-dimensional (i.e., the location information may also include altitude information).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating compliance with location dependent requirements, comprising:
determining location information associated with a user;
determining requirement information based on the location information; and
facilitating the user's compliance with the requirement information.

2. The method of claim 1, wherein the location information is associated with at least one of: (i) latitude and longitude information, (ii) map coordinate information, (iii) a location type, and (iv) an indication of a geographic region.

3. The method of claim 1, wherein the determination of the location information is performed via at least one of (i) a global positioning system device, (ii) a wireless communication network device, (iii) a wireless telephone, and (iv) a Bluetooth device.

4. The method of claim 1, wherein the requirement information is associated with at least one of: (i) a law, (ii) a regulation, and (iii) a rule.

5. The method of claim 1, wherein the requirement information is associated with at least one of: (i) a user action, and (ii) operation of a user device associated with the user.

6. The method of claim 1, wherein the user is associated with a mobile user device, and the mobile user device comprises at least one of: (i) a portable computing device, (ii) a personal digital assistant, (iii) a vehicle, (iv) an automobile, (v) a communication device, (vi) a wireless telephone, (vii) a pager, (viii) a container, and (ix) a weapon.

7. The method of claim 1, wherein the determination of the location information comprises:
receiving the location information at a requirement controller from a remote user device.

8. The method of claim 7, wherein said receiving occurs at least one of: (i) periodically, (ii) upon a change in a location type, and (iii) in association with a requirement request.

9. The method of claim 7, wherein said facilitating comprises:
transmitting the requirement information to the user device.

10. The method of claim 1, wherein the determination of the requirement information comprises:
receiving the requirement information at a user device from a remote requirement controller.

11. The method of claim 10, further comprising:
transmitting the location information to the requirement controller.

12. The method of claim 11, wherein said transmitting is performed at least one of: (i) periodically, (ii) upon a change in a location type, and (iii) in association with a requirement request.

13. The method of claim 11, wherein at least one of the following are also transmitted from the user device to the requirement controller: (i) a user identifier, (ii) a user device identifier, (iii) a requirement request, (iv) a requirement type, (v) user preference information, and (vi) supplemental information.

14. The method of claim 11, wherein said facilitating comprises:
receiving the requirement information from the requirement controller.

15. The method of claim 1, wherein said facilitating comprises:
arranging for an indication to be provided to the user in accordance with the requirement information

16. The method of claim 15, wherein the indication comprises at least one of: (i) text information, (ii) audio information, and (iii) graphical information.

17. The method of claim 15, wherein the indication includes at least one of: (i) a description of a requirement, and (ii) a penalty associated with the requirement.

18. The method of claim 1, wherein said facilitating is further based on supplemental information.

19. The method of claim 18, wherein the supplemental information is associated with at least one of: (i) operation of a user device, (ii) weather information, (iii) a current time, (iv) a current date and (v) user information.

20. The method of claim 1, wherein said facilitating comprises:
automatically arranging for a user device to operate in accordance with the requirement information.

21. The method of claim 1, wherein the determination of the location information is performed by a user device, and the user device determines requirement information via a local location dependent requirement database.

22. The method of claim 1, wherein the determination of the requirement information is associated with at least one of: (i) a location dependent requirement database, (ii) a rules-based system, (iii) a statistical analysis, (iv) human judgment, and (v) a third-party service.

23. The method of claim 1, further comprising:
arranging to receive payment in exchange for facilitating compliance with the location dependent requirements.

24. The method of claim 1, wherein compliance is facilitated with respect to a plurality of location dependent requirement types.

25. An apparatus, comprising:
a processor; and
a storage device in communication with said processor and storing instructions adapted to be executed by said processor to:
determine location information associated with a user;
determine requirement information based on the location information; and
facilitate the user's compliance with the requirement information.

26. The apparatus of claim 25, wherein said storage device further stores at least one of: (i) a location dependent requirement database, and (ii) a requirement request database.

27. The apparatus of claim 25, further comprising:
a communication device coupled to said processor and adapted to communicate with at least one of: (i) a user device, (ii) a requirement controller, (iii) a supplemental information device, and (iv) a payment device.

28. A medium storing instructions adapted to be executed by a processor to perform a method of facilitating compliance with location dependent requirements, said method comprising:
determining location information associated with a user;
determining requirement information based on the location information; and
facilitating the user's compliance with the requirement information.

29. A computer-implemented method of facilitating compliance with location dependent legal requirements, comprising:
receiving current location information from a remote mobile user device via a communication network;
determining a current legal requirement based on the location information; and
transmitting an indication of the current legal requirement to the user device if the current legal requirement differs from a prior legal requirement.

30. A method of facilitating compliance with location dependent requirements, comprising:
determining requirement information;
determining a current location associated with a user;
determining location information based on the requirement information and the current location; and
facilitating the user's compliance with the requirement information.
